(19) United States
(12) Patent Application Publication
(10) Pub. No.: US 2026/0061506 A1
(43) Pub. Date: Mar. 5, 2026

(54) Serrated Cutting Tool for a Rotary Disc or Drum

(71) Applicant: Quadco Inc., Saint-Eustache (CA)

(72) Inventors: Charles HENRICHON, Saint-Eustache (CA); Etienne MINVILLE, Saint-Eustache (CA)

(21) Appl. No.: 19/379,843

(22) Filed: Nov. 5, 2025

Related U.S. Application Data
(63) Continuation-in-part of application No. PCT/CA2024/051030, filed on Aug. 2, 2024.
(60) Provisional application No. 63/517,184, filed on Aug. 2, 2023.

(51) Int. Cl. B23D 61/06; A01G 23/02; B23D 61/02

(52) U.S. Cl. CPC B23D 61/06; A01G 23/02; B23D 61/0225

(57) ABSTRACT

The present disclosure relates to cutting tools for mounting onto a rotary drum or disc of a forestry equipment for cutting ligneous material, the cutting tool comprising: a coupling side for mounting onto the rotary drum or disc; a cutting side opposite the coupling side, the cutting side comprising a concave surface forming a pocket and at least two cutting edges; and at least two lateral sides extending from the coupling end to the cutting end. Each of the cutting edges comprises a plurality of serrations defining valleys or depressions in the concave surface of the cutting side, the valleys extending at different angles relative to a corresponding one of the cutting edges.

### TECHNICAL FIELD

The present invention relates to the field of tree felling, and more particularly relates to a cutting tool for a circular saw or mower drum.

### BACKGROUND

Cutting devices comprising a rotating drum or a rotary disc with cutting teeth are used to shred, cut, or size reduce a material. As the drum or disc rotates, the cutting edge of the teeth dig into the material and remove a depth of the material being shredded to size reduce the material. As the teeth come into contact with the material being shredded, they become dull or blunt, which can increase the cutting resistance. An increase in the cutting resistance can increase the fuel consumption of the machine the rotary drum or disc is being used with. Moreover, an increase in the cutting resistance can increase stress on the other machine components and decrease productivity as the rotational speed of the rotating drum is decreased.

Moreover, once dull, conventional teeth for rotary drums or discs are removed from the rotary drum or disc and replaced with new teeth, increasing the overall cost and maintenance time associated with operating the rotary drum or disc. In some instances, conventional teeth have cutting edges with a single straight edge that extends from either side wall of the tooth or a v-shape edge with two straight edges that converge at or near the center of the cutting tooth at an apex. Straight cutting edges are prone to being worn down and becoming dull and/or blunt, thus increasing the amount of replacement and/or maintenance required with the rotating drum. Another aspect to consider is the discharge of cutting debris, which must be effectively expelled away from the cutting equipment. The accumulation of debris and dust on the front face of the tooth should be avoided.

In view of the above, there is a need for more cost-effective and efficient devices that would be able to overcome or at least minimize some of the above-discussed prior art concerns.

### SUMMARY

It is therefore an aim of the present invention to address the above-mentioned issues.

According to one aspect, there is provided a cutting tool for mounting onto a rotary drum or disc of a forestry equipment for cutting ligneous material. The cutting tool comprises a coupling side for mounting onto the rotary drum or disc; a cutting side opposite the coupling side, the cutting side comprising a concave surface forming a pocket, the cutting side having at least two cutting edges; and at least two lateral sides extending from the coupling side to the cutting side. Each of the cutting edges comprises a plurality of serrations defining valleys or depressions in the concave surface of the cutting side, the valleys extending at different angles relative to a corresponding one of the cutting edges.

In possible embodiments, the at least two cutting edges comprising four cutting edges, each extending between two of the four cutting tips, and wherein the at least two lateral sides comprise four lateral sides flaring from the coupling side to the cutting side.

In possible embodiments, the cutting edges are V-shaped or U-shaped, each leg or half cutting edge of the V-shaped or U-shaped cutting edges comprising two or more serrations.

In possible embodiments, the serrations on each side of the V-shaped or U-shaped cutting edge extend in opposite orientations.

In possible embodiments, each of the cutting edges is formed by a plurality of serration edges.

In possible embodiments, the serrations are arranged symmetrically on each side of a plane passing through the cutting tool axially.

In possible embodiments, each of the valleys comprises a bottom or base, a first side surface extending from the base and, and a second side surface opposite the first side surface.

In possible embodiments, the bottom of each valley extends at an angle relative to a tangent of the cutting edge, the angle being between 15 and 45 degrees.

In possible embodiments, the base is substantially planar, curved, slanted, or angled.

In possible embodiments, the first side surface and/or the second side surface is substantially planar, curved, slanted, or angled.

In possible embodiments, at least some of the valleys or depressions are delimited by ridges, at least two adjacent valleys sharing a same ridge.

In possible embodiments, at least some of the serrations form arc-shaped grooves extending between two adjacent cutting edges.

In possible embodiments, the at least one groove is provided on the cutting surface at an angle with an axis perpendicular to a corresponding one of the cutting edges.

In possible embodiments, for each of the cutting edges, the serrations on one half of the cutting edge are curved and oriented toward an adjacent lateral side of the tooth, and the serrations on the other half of the cutting edge are curved and oriented toward an opposite lateral side, also adjacent to the cutting edge, so as to direct wood fragments or chips toward both lateral sides of the tooth.

In possible embodiments, the at least two cutting edges comprise a top cutting edge on the top surface and a bottom cutting edge on the bottom surface that is opposing the top cutting edge and the at least one groove comprises at least one top groove on the top cutting edge and at least one bottom groove on the bottom cutting edge.

In possible embodiments, the cutting tool is configured to be rotatable, such that the cutting tool is configured to be mounted to the rotary drum or disc in a first position with a first one of the at least two cutting edges being in a cutting path of the rotary drum or disc and in a second position with a second one of the at least two cutting edges being in the cutting path.

In possible embodiments, the cutting tool is configured to be rotatable in four different positions, by rotating the tooth 90 degrees, each position exposing a different set of serrations along the cutting path.

In possible embodiments, the cutting tool is provided with an annular elevation or mound surrounding the bolt hole, and mound depressions formed therein, the annular elevation or mound blocking wood fragments or chips from the cutting tool center, the mound depressions cooperating with the serrations provided on the cutting edges to guide the wood fragments or chips toward the opposite lateral sides of the cutting tool.

In possible embodiments, the serrations may serve as wear indicators, the disappearance of the serrations on one of the cutting edges indicating that the cutting tool is to be replaced or rotated to another position to expose another one of the cutting edges.

In possible embodiments, the cutting tool is for use in a mulching attachment or in a felling head and may be provided on the outer periphery of a circular saw disk.

### BRIEF DESCRIPTION OF THE DRAWINGS

In order that the invention may be readily understood, embodiments of the invention are illustrated by way of examples in the accompanying drawings.

FIG. 1A is a front or leading view of a cutting tool according to one embodiment;

FIG. 1B is a side view the cutting tool shown in FIG. 1A;

FIG. 1C is a perspective side view of the cutting tool shown in FIG. 1A;

FIG. 1D is a perspective rear or trailing view of the cutting tool shown in FIG. 1A;

FIG. 2A is a perspective front or leading view of a cutting tool according to another embodiment;

FIG. 2B is a perspective rear or trailing view of the cutting tool shown in FIG. 2A;

FIG. 2C is a front or leading view of the cutting tool shown in FIG. 2A;

FIG. 3A is a front or leading view of a cutting tool according to another embodiment;

FIG. 3B is a perspective rear or trailing view of the cutting tool shown in FIG. 3A;

FIG. 3C is a perspective front or leading view of the cutting tool shown in FIG. 3A;

FIG. 4A is a perspective front or leading view of a cutting tool according to another embodiment;

FIG. 4B is a perspective rear or trailing view of the cutting tool shown in FIG. 4A;

FIG. 4C is a front or leading view of the cutting tool shown in FIG. 4A;

FIG. 5A is a perspective front or leading view of a cutting tool according to another embodiment;

FIG. 5B is a perspective rear or trailing view of the cutting tool shown in FIG. 5A;

FIG. 5C is a front or leading view of the cutting tool shown in FIG. 5A;

FIG. 5D is a side view of the cutting tool shown in FIG. 5A;

FIG. 6A is a perspective front or leading view of a cutting tool according to another embodiment;

FIG. 6B is a perspective rear or trailing view of the cutting tool shown in FIG. 6A;

FIG. 6C is a front or leading view of the cutting tool shown in FIG. 6A;

FIG. 7A is a front or leading view of a cutting tool according to another embodiment;

FIG. 7B is a side view of the cutting tool shown in FIG. 7A;

FIG. 8A is a front or leading view of a cutting tool according to another embodiment;

FIG. 8B is a side view of the cutting tool shown in FIG. 8A;

FIG. 8C is a perspective front or leading view of the cutting tool shown in FIG. 8A;

FIG. 9 is a side view of a plurality of cutting tools according to one embodiment coupled to an exemplary cutting drum;

FIG. 10 is a perspective front or leading view of the cutting tool shown in FIG. 1A with a portion shown in stippled lines that is case hardened;

FIG. 11 is a perspective front or leading view of the cutting tool shown in FIG. 2A with a portion shown in stippled lines that is case hardened;

FIG. 12 is a schematic showing a comparison of the wear patterns of the cutting tool shown in FIG. 2A with (a) no wear, (b) moderate wear, and (c) extensive wear and the cutting tool shown in FIG. 1A with (d) no wear, (e) moderate wear, and (f) extensive wear, as well as a matching side profile of a cutting tool with (g) no wear, (h) moderate wear, and (i) extensive wear.

FIGS. 13A to 13F show different views of a cutting tool, according to a possible embodiment.

FIGS. 14A to 14F show different views of a cutting tool, according to another possible embodiment.

FIGS. 15A to 15F show different views of a cutting tool, according to another possible embodiment.

FIG. 16 shows a holder and a cutting tool according to a possible embodiment.

FIG. 17 shows a rotary disk provided with cutting tools mounted thereon.

FIG. 18 shows a rotary drum provided with cutting tools mounted thereon.

FIGS. 19A and 19B shows according to two embodiments, where it can be seen that a four-sided cutting tool with curved edges and serrations (left side of FIGS. 19A and 19B) allows the material to be cut more finely than with a straight-edged cutting tool with serrations.

### DETAILED DESCRIPTION

In the following description, the same numerical references refer to similar elements. The embodiments described in the present description are preferred embodiments only; they are given solely for exemplification purposes.

In addition, it will be appreciated that positional descriptions such as “top”, “bottom”, “side”, “lower”, “upper”, and the like should, unless otherwise indicated, be taken in the context of the figures and should not be considered as limiting or as implying a required orientation during use.

There is provided a cutting tool that has features to increase the service life of the cutting tool with respect to wear and erosion, and contributes to reduction in cutting resistance, even after a long interval of utilization. The reduction in cutting resistance is retained without external interventions, such as mechanical grinding, buffing, or sharpening. The cutting tools also have improved debris discharge features. To reduce the cutting resistance in the cutting plane, the cutting tools can have a cutting edge that is a serrated or wavy and which may include at least three edges extending in at least three planes or directions. In some embodiments, the cutting edges include a plurality of grooves or serrations that each add at least two serration edges to the cutting edge on the cutting tool. In some embodiments, the cutting edge can include edge surfaces extending in a plane that is different from an edge plane of the at least one cutting edge. In some embodiments, the cutting edge can include grooves or serrations that have edge surfaces extending in a plane different than a plane of the cutting edge.

When the rotary drum or disc is rotated, the cutting tools are susceptible to damage from impacting objects other than the organic material being shredded or grinded, such as rocks. The cutting teeth with grooves or serrations can be resistant to dents or other damage on the edges of the cutting tool. Moreover, in contrast to straight edges, resistance to dents or damage on the edge can improve as the cutting tool is being used (i.e., as the cutting edges are worn down from use) as the cutting edges and surfaces of the cutting tool become rounded, which spreads the impact load of the non-organic material more evenly on the cutting edges without drastically reducing the productivity of the cutting tool. In addition, the serrations not only contribute to cutting efficiency, but also serve as wear indicators, as when all the serrations have disappeared, this indicates that the tooth needs to be rotated and/or resharpened.

In some embodiments, the grooves or serrations on the cutting edge of the cutting tool can provide improved debris discharge features and contribute to producing a smaller size of the shredded material. As the cutting edge hits the material being shredded first, the grooves or serrations provide less surface area available to the material at the first point of contact than a straight blade. For example, if a cutting tool has a width of 6 cm and a straight blade without grooves or serrations that extends the entire width of the cutting tool (i.e., a 6 cm long cutting edge), all 6 cm of the cutting edge will come into contact with the material being shredded. However, when the cutting edge is provided with 4 grooves having a width at the cutting edge of about 1 cm, then only 2 cm of the cutting edge is coming into contact with the material at the first point of contact.

After the initial or first point of contact, the edges of the groove then come into contact with the material, producing a smaller sized material, which can be desirable as the shredded organic matter will decompose faster than larger pieces. These smaller pieces of shredded organic matter can be directed through the grooves on the leading surface of the cutting tool, thus providing better debris discharge. In some embodiments, the leading surface has a higher surface area than the other surfaces of the cutting tool and/or is formed as a concave shape such that it is geometrically stronger than other surfaces of the cutting tool. As such, when the smaller pieces of the shredded organic matter are directed through the grooves on the leading surface, the wear or erosion impact is reduced or minimized.

In some embodiments, the cutting tool is configured to be rotatable such that the cutting tool has more than one cutting edge on the leading side that can be used until the end of the cutting edge's wear or erosion life. For example, when a leading side of the rotatable cutting tool includes two cutting edges, the wear or erosion life of the cutting tool can be at least doubled by rotating the cutting tool to utilize a second cutting edge. Similarly, if the leading side (or cutting side) of the rotatable cutting tool includes four cutting edges, the wear or erosion life of the cutting tool can be at least quadrupled by rotating the cutting tool by 90 degrees, to utilize the other cutting edges. In some embodiments, the cutting tool is configured to be reversible such that the cutting tool has more than one cutting edge on opposing or adjacent surfaces, such that multiple surfaces on the cutting tool are configured to be the leading side of the cutting tool. In some embodiments, the cutting tool has two opposing cutting edges on a leading side and two opposing cutting edges on a trailing side. In this embodiment, both the leading side and the trailing side are rotatable to each provide two wear or erosion lives of the cutting tool. Moreover, the cutting tool is reversible, such that the cutting tool can be flipped to orientate the trailing side as the leading side, thus providing a total of four erosion or wear lives to the cutting tool. In some embodiments, some or all of the cutting edges on the reversible and/or rotatable cutting tool can include grooves or serrations.

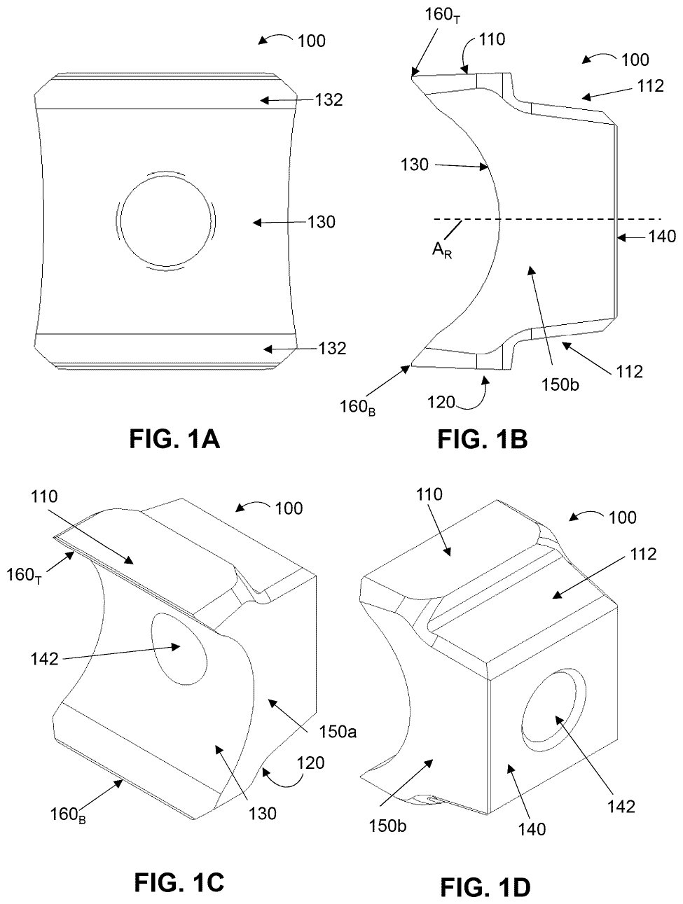

Referring now to FIGS. 1A to 1F, a cutting tool 100 according one embodiment is shown. The cutting tooth 100 has a top surface 110, a bottom surface 120, a leading or cutting surface 130, a trailing or coupling surface 140, a first side surface 150a, and a second side surface 150b that are close to perpendicular to the top surface 110 and the bottom surface 120.

In the exemplary embodiment, the top surface 110 and the bottom surface 120 each have a relief surface 112 that is recessed from the top surface 110 or bottom surface 120, such that the leading side of the cutting tool 100 (the cutting surface 130) is larger than the trailing side (the coupling surface 140).

In the exemplary embodiment, the cutting surface 130 is on a leading side of the cutting tool 100, such that the cutting surface 130 faces the direction of rotation while the rotating drum or mulcher head is in use. The leading side of the top surface 110 (i.e., the apex between the cutting surface 130 and the top surface 110) has a top cutting edge 160T and the leading side of the bottom surface 120 (i.e., the apex between the cutting surface 130 and the bottom surface 120) has a bottom cutting edge 160; extending between the first side 150a and the second side 150b. In some embodiments, the cutting surface 130 further includes a blade surface 132 adjacent to the top cutting edge 160T and/or the bottom cutting edge 160g. In the exemplary embodiment, the blade surfaces 132 are each a planar surface that is adjacent to the concave shape of the cutting surface 130, such that a first one of the blade surfaces 132 extends between the top cutting edge 160T and the concave surface of the cutting surface 130 and a second one of the blade surfaces 132 extends between the bottom cutting edge 160; and the concave surface of the cutting surface 130.

The coupling surface 140 is on a trailing side of the cutting tool 100, such that the coupling surface 140 faces a direction that is opposite that of the direction of rotation of the rotating drum or disc. In some embodiments, the coupling surface 140 further includes an aperture 142 that is configured to receive a fastener to couple the cutting tool 100 to a leading side of the cutting drum or disc or a tool holder on the cutting drum or disc.

In the exemplary embodiment, the cutting tool 100 is configured to be rotatable, such that when the cutting edge in the cutting path gets dull or blunt, the cutting tool 100 can be removed and rotated, such that the second cutting edge can be placed in the cutting path. For example, the cutting tool 100 can be removably coupled to a cutting drum or tool holder on the cutting drum such that the top cutting edge 160T is in the cutting path. During use, when the top cutting edge 160T gets dull or blunt, the cutting tool 100 can be loosened or removed and rotated 180° along an axis of rotation A_{R} that is coaxial to the fastener in the aperture 142, such that the bottom cutting edge 160B is in the cutting path. Once rotated, the fastener can be tightened or the cutting tool 100 can be re-removably coupled to the cutting drum or tool holder with the fastener.

In the exemplary embodiment, the top cutting edge 160T and the bottom cutting edge 160B are opposing each other. However, it is also contemplated that the first and/or second side surface 150a, 150b can include a cutting edge. For example, the cutting tool 100 can include four cutting edges on each of the top surface 110, the bottom surface 120, and the first and second side surfaces 150a, 150b, such that when rotating the cutting tool 100, the cutting tool 100 would only be rotated 90° when moving the cutting tool to a second or subsequent position.

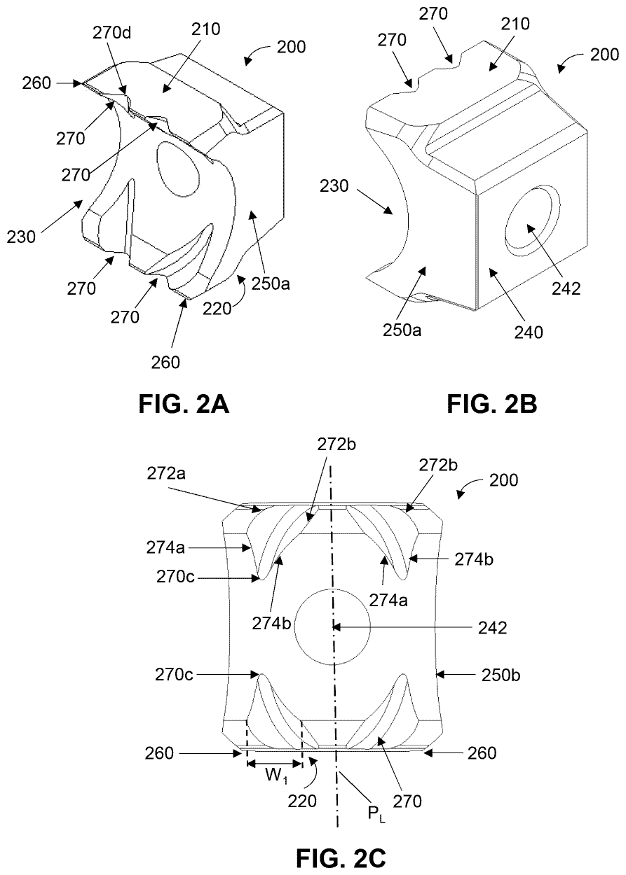

Referring now to FIGS. 2A to 2C, a cutting tool 200 according to one embodiment of the present disclosure is shown. The cutting tool 200 includes a body having a top surface 210, a bottom surface 220, a leading or cutting surface 230, a trailing or coupling surface 240, a first side surface 250a, and a second side surface 250b. The first and second side surfaces 250a, 250b and the coupling surface 240 are close to perpendicular to the top surface 210 and the bottom surface 220. In the exemplary embodiment, the cutting surface 230 has a substantially concave surface, which can provide a recess for the debris of the material being shredded to move away from the cutting surface 230 during rotation of the rotating drum. The concave surface also increases the geometric strength of the leading side of the cutting tool 200.

In the exemplary embodiment, the cutting surface 230 is on the leading side of the cutting tool 200, such that the cutting surface 230 faces the direction of rotation while the rotating drum or mulcher head is in use. The leading side of the top surface 210 and the bottom surface 220 each have a cutting edge 260 (i.e., the cutting surface 230 has at least two cutting edges 260). The coupling surface 240 is on the trailing side of the cutting tool 200, such that the coupling surface 240 faces a direction that is opposite that of the direction of rotation of the rotating drum. In some embodiments, the coupling surface 240 further includes an aperture 242 that is configured to receive a fastener to couple the cutting tool 200 to a leading side of the cutting drum or disc or a tool holder on the cutting drum or disc.

In the exemplary embodiment, the cutting edges 260 each include two grooves 270 extending through the cutting edge 260 from the top surface 210 to the cutting surface 230. The grooves 270 each comprise two opposing groove edges on the top surface 210 that define the groove 270 on the top surface 210 and two opposing groove edges on the cutting surface 220 that define the groove 270. However, it is contemplated that the grooves 270 can extend only partially or substantially through the cutting edge, such that the grooves 270 only include groove edges on the top surface 210 or only include the groove edges on the cutting surface 230.

As is best shown in FIGS. 2A and 2C, each of the grooves 270 has outer grooves on the top surface 210 (a first side top edge 272a and a second side top edge 272b) that are spaced apart and opposed to each other to define the groove 270 on the top surface 210. The cutting surface 230 of each groove 270 has cutting grooves edges (a first side leading edge 274a and a second side leading edge 274b) that are spaced apart and opposed to each other to define the groove 270 on the cutting surface 230. The groove edges 272a, 272b, 274a, 274b co-operate with the cutting edge 260 to increase the accumulative surface area of the edges that are engaging with and cutting into the material being shredded.

In some embodiments, the grooves 270 can be curved, for example, to increase the accumulative surface area of the edges that engage with the material being shredded. In the exemplary embodiment, as best shown in FIG. 2C, the grooves 270 are curved laterally outwardly from the top surface 210 to the cutting surface 230. In other words, a leading end 270c of the groove 270 is further from a center vertical plane P_{L} of the cutting tool 200 than a trailing end 270d of the groove 270. However, it is contemplated that other configurations are possible, such that the grooves 270 are curved laterally inwardly from the top surface 210 to the cutting surface 230, are straight, or are at the same or different angles.

In some embodiments, the grooves 270 can include a base 276, a first side surface 278a, and a second side surface 278b. In such embodiments, the first side top edge 272a and the first side leading edge 274a are defined by the apex between the first side surface 278a and the top surface 210 and the cutting surface 230, respectively. Similarly, the second side top edge 272b and the second side leading edge 274b are defined by the apex between the second side surface 250b and the top surface 210 and the cutting surface 230, respectively.

The base 276 can be substantially planar, curved, such as a concave curve or a convex curve, slanted, or angled. Similarly, the first and second side surfaces 278a, 278b can be substantially planar, curved, such as a concave curve or a convex curve, slanted, or angled. In the exemplary embodiment, the base 276 is substantially planar and the first and second side surfaces 278a, 278b are tapered away from the base 276, such that the width of the base 276 is smaller than a width between the first side top edge 272a and the second side top edge 272b and a width between the first side leading edge 274a and the second side leading edge 274b. In other embodiments, one or both of the first and second side surfaces 278a, 278b can extend to the top surface 210 and the cutting surface 230 in a substantially perpendicular manner and/or one or both of the first and second side surfaces 278a, 278b can extend to the top surface 210 and the cutting surface 230 at an angle.

In some embodiments, the width W₁ of the groove 270 at the cutting edge 160 corresponds to the reduction in surface area that contacts the material being shredded at a point of first contact. In other words, the accumulative surface area at the point of first contact is the surface area of the cutting edge 160 minus the widths W₁ of each of the grooves 270 at the cutting edge. In the exemplary embodiment, the width W₁ of the groove 270 at the cutting edge 160 is the widest portion of the grooves 270.

In some embodiments, the first and second side surfaces 278a, 278b can extend to the top surface 210 and the cutting surface 230 with a varying angle, such that the width between the first side top edge 272a and the second side top edge 272b and the width between the first side leading edge 274a and the second side leading edge 274b differ. For example, the leading side of the groove 270, defined by the first and second side leading edges 274a, 274b can have a larger width than the width W₁ of the groove 270 in line with the cutting edge 260 and the width of a trailing side of the groove 270, defined by the first and second side top edges 272a, 272b.

It is contemplated that the grooves 270 can have any shape or configuration. In some embodiments, the grooves 270 are square grooves, bevel grooves, V-shaped grooves, J-shaped grooves, U-shaped grooves, flare bevel grooves, flare V-shaped grooves, etc. In some embodiments, a portion, a majority, or an entirety of the first side surface 278a and/or the second side surface 278b can be planar, convex curved, concave curved, perpendicular with respect to the top surface 210 or the bottom surface 220, perpendicular with respect to the cutting surface 230, angled with respect to the top surface 210 or the bottom surface 220, and/or angled with respect to the cutting surface 230.

It is further contemplated that other type of grooves, serrations, or non-straight cutting edge surfaces can be utilized. For example, in some embodiments, the cutting edges 260 can be serrated, saw-toothed, zig-zagged, or notched so as to provide additional edges to the cutting edge 260.

In some embodiments, the cutting tool 200 comprises at least three edges configured to engage with and size reduce the organic material that extends in at least three planes or directions. For example, referring to FIG. 2C, the cutting tool 200 includes nine edges extending in nine directions: the cutting edge 260 that extends in a first direction; two first side top edges 272a extending in a second and third direction (i.e., one on each groove 270), two second side top edges 272b extending in a fourth and fifth direction, two first side leading edges 274a extending in a sixth and seventh direction and two second side leading edges 274b extending in an eighth and ninth direction.

However, it is contemplated that a cutting tool can have three edges extending in three planes or directions or three edges that are non-collinear. For example, a cutting tool 200 can include a single groove 270 provided only on the cutting surface 230, such that the cutting tool 200 includes the cutting edge 260 extending in a first direction, a first side leading edge 274a extending in a second direction, and a second side leading edge 274b extending in a third direction. Any other configurations that provide at least three edges extending in three planes or directions are also possible.

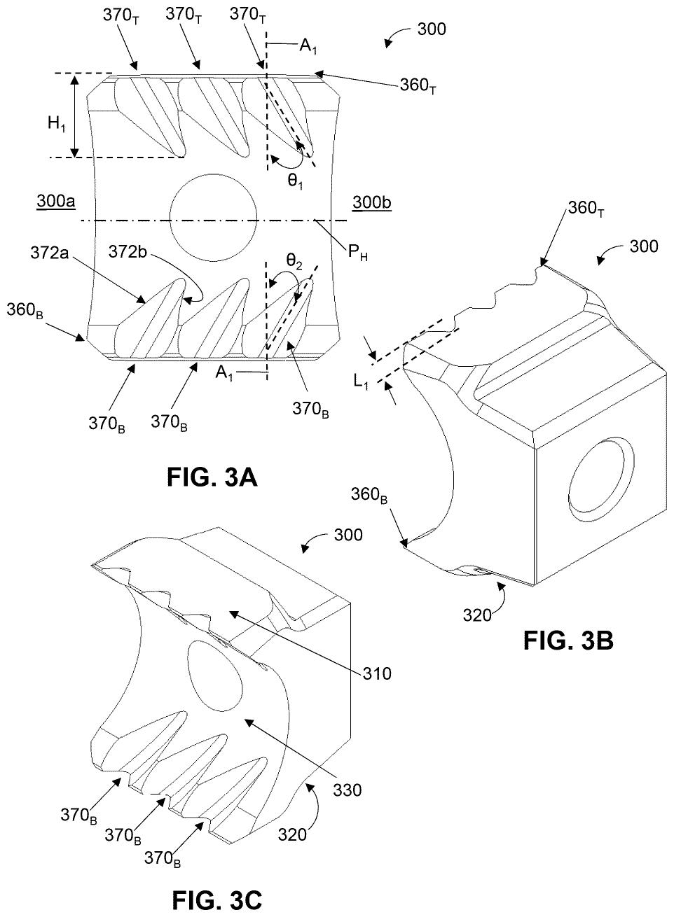

Referring now to FIGS. 3A to 3C, a cutting tool 300 having a body with substantially similar features to body of the cutting tool 200 is shown. The cutting tool 300 differs in the number, shape, and orientation of the grooves. The cutting tool 300 includes a top cutting edge 360_{T} extending between the side walls of the body on the top surface 310 and a bottom cutting edge 360_{B} extending between the side walls on the bottom surface 320. In this embodiment, the cutting tool 300 includes three top grooves 370_{T} extending through the top cutting edge 360_{T} from the top surface 310 to the cutting surface 330 and three bottom grooves 370_{B} extending through the bottom cutting edge 360_{B} from the bottom surface 320 to the cutting surface 330.

In this embodiment, both the top grooves 370_{T} and the bottom grooves 370_{B} extend through the top cutting edge 360_{T} at an angle θ₁, θ₂ toward a second side 300b of the body. In other words, the top grooves 370_{T} and the bottom grooves 370_{B} have mirrored symmetry along a center horizontal plane P_{H} extending from the first side 300a to the second side 300b through a center of the cutting tool 300. In such embodiments, when the cutting tool 300 in a first position is removed from the cutting drum or the tool holder and rotated to the second position, the cutting edge in the cutting path of the second position has grooves with an opposite orientation than the cutting tool in the first position before being rotated. For example, if the cutting tool 300 was used in a cutting holder with the top cutting edge 360_{T} being placed in the cutting path first, once that top cutting edge 360_{T} was worn down, the cutting tool 300 could be removed or loosened and rotated such that the bottom cutting tool 360_{B} is in the cutting path. When the bottom cutting tool 360_{B} is in the cutting path, the orientation of the bottom grooves 370_{B} are opposite that of the top grooves 370 when the top cutting edge 360_{T} is in the cutting path.

In other embodiments, the orientations or direction of the top grooves 370_{T} can have an orientation or direction that is parallel to the orientation or direction of the bottom grooves 370_{B}, such that when rotated, the grooves in the cutting path have the same orientation whether they are the top grooves 370_{T} or the bottom grooves 370_{B}. For example, the top grooves 370_{T} can extend through the top surface 310 of the top cutting edge 360_{T} toward the second side 300b of the cutting surface 330, whereas the bottom grooves 370_{B} can extend through the bottom surface 320 of the bottom cutting edge 360_{B} toward a first side 300a of the cutting surface 330.

In some embodiments, the top grooves 370_{T} can extend or pass through the top cutting edge 360_{T} at an angle θ₁ to an axis A₁ perpendicular to the top cutting edge 360_{T}. The bottom grooves 370_{B} can extend through the bottom cutting edge 360_{B} from the bottom surface 320 to the cutting surface 330 at an angle θ₂ to an axis A₁ perpendicular to the bottom cutting edge 360_{B}. In some embodiments, the angle θ₁ of the top grooves 370_{T} is different from the angle θ₂ of the bottom grooves 370_{B}. In the exemplary embodiment, the angle θ₁ of the top grooves 370_{T} is substantially equal to the angle θ₂ of the bottom grooves 370_{B}. The angles θ₁, θ₂ of the top and bottom grooves 370_{T}, 370_{B}, respectively, can be between about 1° and 50°, or between about 15° and about 45°.

As the rotary cutting drum rotates, the top or bottom cutting edge 360_{T}, 360_{B} in the cutting path first comes into contact with the material to be shredded, followed by the top or bottom grooves 370_{T}, 370_{B} and the cutting surface 330 of the cutting tool 300. Accordingly, the top or bottom cutting edge 360_{T}, 360_{B} in the cutting path and the leading or cutting side of the corresponding top or bottom grooves 370_{T}, 370_{B} can have increased wear during use of the rotary drum or disc. In some embodiments, the groove edges on the cutting surface 330 have a height H₁ on the leading side that is longer than a length L₁ of the groove edge on the top surface 310. In some embodiments, the groove edges on the cutting surface 330 are substantially longer than the groove edges on the top surface 310 to account for the additional erosion the cutting surface 330 is subjected to.

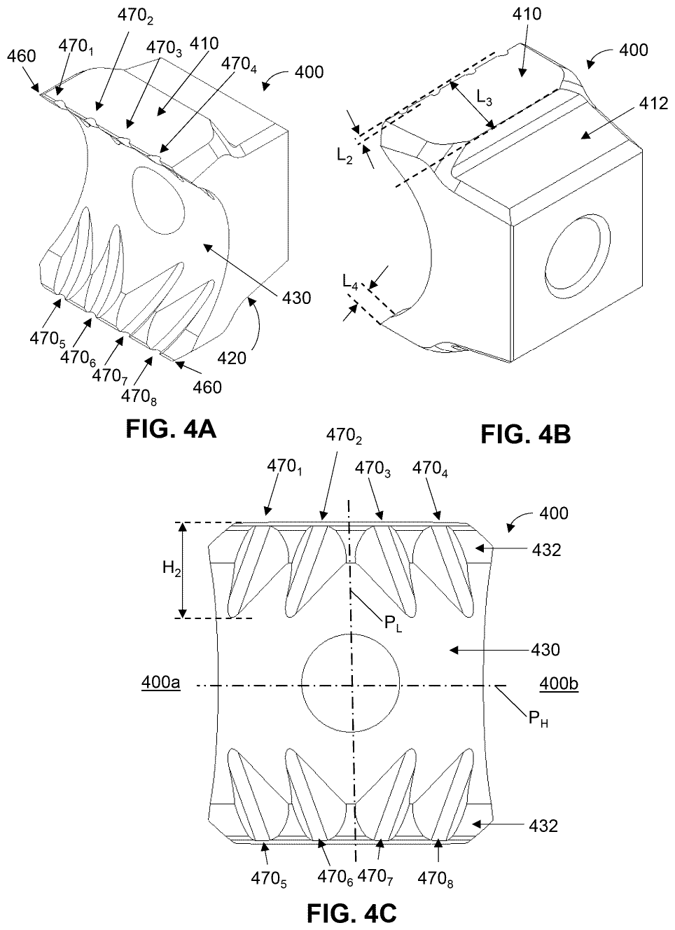

Referring now to FIGS. 4A to 4C, a cutting tool 400 having a body with substantially similar features to the body of the cutting tool 200 is shown. The cutting tool 400 differs in the number, shape, and orientation of the grooves. The cutting tool 400 includes top and bottom cutting edges 460 extending between the side walls of the body on the top surface 410 and the bottom surface 420, respectively. In some embodiments, the top surface 410 and/or the bottom surface 420 includes a relief surface 412 that is recessed from the top surface 410 or the bottom surface 420. A leading side of the cutting tool 400 has a concave cutting surface 430 with a blade surface 432 adjacent to each of the cutting edges 460. In this embodiment, the cutting tool 400 includes four grooves 470₁₋₄ extending through the cutting edge 460 on the top surface 410 and four grooves 470₅₋₈ extending through the cutting edge 460 on the bottom surface 420.

In some embodiments, a majority of the edges on the grooves 470₁₋₈ are on the cutting surface 430, such that a length L₂ of the edges on the top surface 410 for grooves 470₁₋₄ or the bottom surface 420 for grooves 470₅₋₈ is relatively short compared to a height H₂ of the groove edges on the cutting surface 430. For example, the height H₂ of the groove edges on the cutting surface 430 is between about 2 and about 20 times the length L₂ of the edges on the top surface 410 or bottom surface 420. In the exemplary embodiment, the height H₂ of the edges on the cutting surface 430 is about 10 times the length L₂ of the edges on the top surface 410.

In some embodiments, the length L₂ of the edges or edge surfaces on the top surface 410 or bottom surface 420 (outer groove edges) can be related to the length L₃ of the top surface 410 or bottom surface 420. For example, the length L₂ of the edges on the top surface 410 or the bottom surface 420 can be between about 1% and about 90% of the length L₃ of the top surface 410 or bottom surface 420, or between about 10% and 60% of the length L₃ of the top or bottom surface 410, 420. In the exemplary embodiment, the length L₂ of the edges on the top surface 410 or bottom surface 420 (outer groove edges) are about 1.88 mm from the cutting edge 460 and the length L₃ of the top or bottom surface 410, 420 is about 19.39 mm. Accordingly, the length L₂ of the outer groove edges is about 10% of the length L₃ of the top surface 410. In other embodiments, for example referring back to FIGS. 2A to 3C, the length of the outer groove edges of the grooves 270, 370 on the top surface 210, 310 of the cutting tool 200, 300 is about 20% of the length of the top surface 210, 310.

Similarly, in some embodiments, the height H₂ of the groove edges on the cutting surface 430 can be related to the length La of the blade surface 432. For example, the height H₂ of the groove edges on the cutting surface 430 can be between about 1% and about 350% of the length L₄ of the blade surface 432, or between about 80% and 300% of the length La of the blade surface 432. In the exemplary embodiment, the height H₂ of the groove edges on the cutting surface 430 are 16.96 mm from the cutting edge 460 and the length L₄ of the blade surface 432 is about 8.20 mm. Accordingly, the height H₂ of the groove edges on the cutting surface 430 is about 207% of the length La of the blade surface 432. In other embodiments, for example referring back to FIGS. 2A to 3C, the height of the groove edges for grooves 270, 370 on the cutting surface 230, 330 of the cutting tool 200, 300 is about 230% and 240%, respectively, of the height of the blade surface. However, it is contemplated that the leading side height of the groove edges on the cutting surface can be equal to or less than the length of the blade surface of the cutting tool.

In some embodiments, the grooves 470₁₋₈ can extend at an angle with an axis perpendicular to the cutting edge in different directions. In some embodiments, the row of top grooves 470₁₋₄ and the row of bottom grooves 470₅₋₈ have an orientation such that they have mirror symmetry along the horizontal plane P_{H}. In some embodiments, opposing grooves (such as the first and fifth grooves 470_{1,5} or fourth and eighth grooves 470_{4,8}) extend toward the same side surface of the cutting tool 400. In the exemplary embodiments, the first, second, fifth, and sixth grooves 470_{1,2,5,6} extend toward the first side 400a and the third, fourth, seventh, and eighth grooves 470_{3,4,7,8} extend toward the second side 400b.

In some embodiments, the grooves 470₁₋₈ have mirrored symmetry along a center vertical plane P_{L} extending from the top surface 410 to the bottom surface 420 through a center of the cutting tool 300.

In some embodiments, the grooves 470₁₋₈ that are complementary to each other are orientated parallel or substantially parallel to each other, such that when the cutting tool 400 is rotated, the first one of the complimentary grooves is in the same position as the second one of the complimentary grooves. As used herein, complimentary grooves means grooves 470₁₋₈ that are in the same position when the cutting edge 460 the groove 470₁₋₈ is on is in the cutting path. For example, the first and eighth grooves 470_{1,8} are complimentary grooves because, when the cutting tool 400 is in a first cutting position with the cutting edge 460 on the top surface 410 being in the cutting path, the first groove 470₁ is at an outer position on the left-hand side, when looking at the leading side (cutting surface 430). When the cutting tool 400 is rotated 180°, such that the cutting tool 400 is in a second cutting position with the cutting edge 460 on the bottom surface 420 being in the cutting path, the eighth groove 470₈ is at the outer position on the left-hand side.

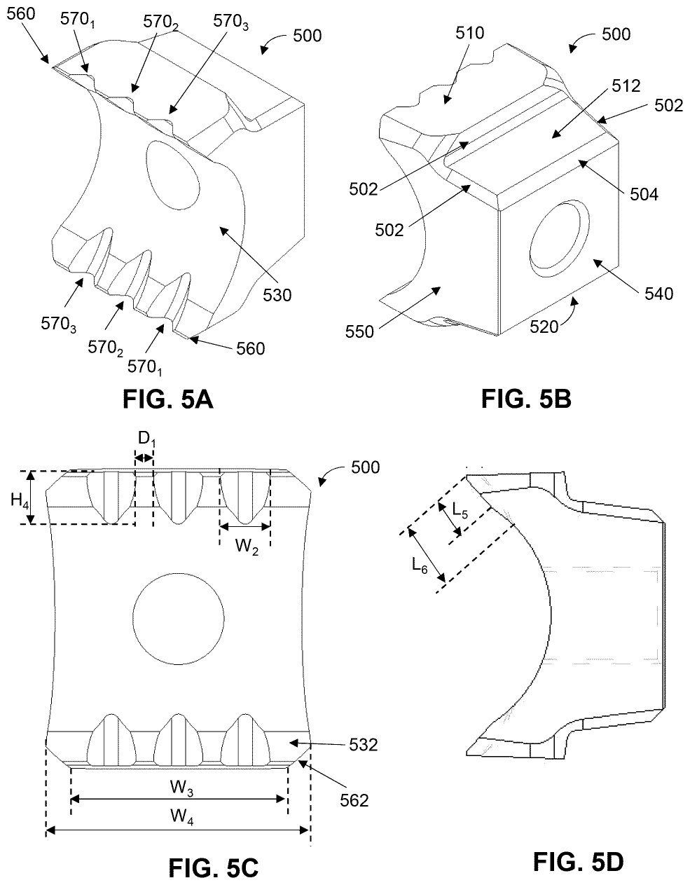

Referring now to FIGS. 5A to 5C, a cutting tool 500 having a body with substantially similar features to the body of the cutting tool 200 is shown. The cutting tool 500 differs in the number, shape, and orientation of the grooves. The cutting tool 500 includes opposing cutting edges 560 with three pairs of corresponding grooves 570₁₋₃ (three grooves 570₁₋₃ on one cutting edge 560 and three corresponding grooves 570₁₋₃ on the opposing cutting edge 560). Each of the opposing cutting edges 560 are adjacent to a blade surface 532 on a leading side of the cutting tool 500. In some embodiments, the corresponding grooves 570₁₋₃ have substantially the same orientation. In the exemplary embodiment, the corresponding pair of grooves 570₁₋₃ are orientated substantially perpendicular to the cutting edges 560.

The corresponding grooves 570₁₋₃ each have a cutting side height H₄ that can extend from the cutting edge 560 to the leading end of the corresponding groove 570₁₋₃. For example, the cutting side height H₄ can be between about 1 mm and about 25 mm, or between about 5 mm and about 15 mm. In the exemplary embodiment, the cutting side height H₄ (i.e., the leading side height of the cutting side groove edges) is 10.43 mm and a length L₅ of the blade surface 532 is about 8.20 mm (in other words, the height H₄ of the groove edges on the cutting surface is 127% of the length L₅ of the blade surface 532).

The skilled artisan will understand that, due to the blade surface 532 being tapered and the cutting surface 530 being concave, a length Le of the cutting side groove edges on the corresponding grooves 570₁₋₃ is greater than the height H₄ of the grooves when viewing from the leading side. In some embodiments, the length Le of the groove edges on the cutting surface 530 (measured from the cutting edge 560 to the leading end of the groove along the curve of the cutting surface 530) can be between about 1 mm and about 40 mm, or between about 10 mm and about 20 mm. For example, the length Le of the groove edges on the cutting surface 530 can be between about 50% and about 300% of the length L₅ of the blade surface 532, or between about 90% and about 200% of the length L₅ of the blade surface 532. In the exemplary embodiment, the length Le of the groove edges on the cutting surface 530 is 13.45 mm corresponding to about 164% of the length L₅ of the blade surface 532.

In some embodiments, the width of the corresponding grooves 570₁₋₃ can vary along a length of the groove. In the exemplary embodiment, the width of the corresponding grooves 570₁₋₃ are the same, with each having a widest width W₂ (i.e., a width at the widest part of the corresponding grooves 570₁₋₃) of between about 1 mm and about 20 mm, or between about 5 mm and about 15 mm. In the exemplary embodiment, the widest width W₂ of each of the corresponding grooves 570₁₋₃ is about 9.34 mm.

In some embodiments, the first side and the second side of the cutting edges 560 can be tapered such that a width W₃ of the cutting edge 560 is less than a width W₄ of the cutting tool 500. The tapered surface 562 can help prevent material from catching on a corner of the leading side (the apex of the cutting surface 530, the bottom surface 520, and a respective one of the sides). Similarly, the surface interface 502 between the top surface 510 or bottom surface 520 and the side surfaces 550 or the surface interface 504 between the coupling surface 540 and the top surface or the bottom surface 520 can be tapered. In the exemplary embodiment, the width W₃ of the cutting edge 560 is 42.33 mm and the width W₄ of the cutting tool 500 is 50.32 mm.

In some embodiments, adjacent ones of the corresponding grooves 570₁₋₃ on the same cutting edge 560 can be spaced apart along the width W₃ of the cutting edge 560 at the same or varying distances. For example, the corresponding grooves 570₁₋₃ can be spaced apart by a distance D₁ of between about 1 mm and about 10 mm. In the exemplary embodiment, the distance D₁ between adjacent ones of the corresponding grooves 570₁₋₃ is 3.36 mm.

It is contemplated that the distance D₁ between adjacent ones of the corresponding grooves 570₁₋₃ depends on the width W₃ of the cutting edge 560 (which is dependent on the width W₄ of the cutting tool 500) and the widest width W₂ of the grooves 570₁₋₃. For example, the distance D₁ between adjacent ones of the corresponding grooves 570₁₋₃ can be adjusted based on the width W₃ of the cutting edge 560 and the widest width W₂ of the corresponding grooves 570₁₋₃, such that between 25 and 90% of the cutting edge 560 includes the corresponding grooves 570₁₋₃. In some embodiments, at least 50% of the width W₃ of the cutting edge 560 includes the corresponding grooves 570₁₋₃. For example, in the exemplary embodiment, the total surface area of the three corresponding grooves 570₁₋₃ is 28.02 mm, corresponding to about 56% of the width W₃ of the cutting edge 560.

It is understood that each of the dimensions described herein are relative to the size of the tooth. The exemplary cutting tools 200, 300, 400, and 500 are each based on a 2″ kerf tooth, which has an overall width of about 50.32 mm (1.981 inches). However, the size of the cutting tool can vary greatly depending on the type of rotary drum or disc the cutting tool is being used with.

In some embodiments, the top surface 510 and/or the bottom surface includes a relief surface 512. The surface interface 514 between the portion of the top surface that includes the cutting edge 560 and the relief surface 512 can be tapered.

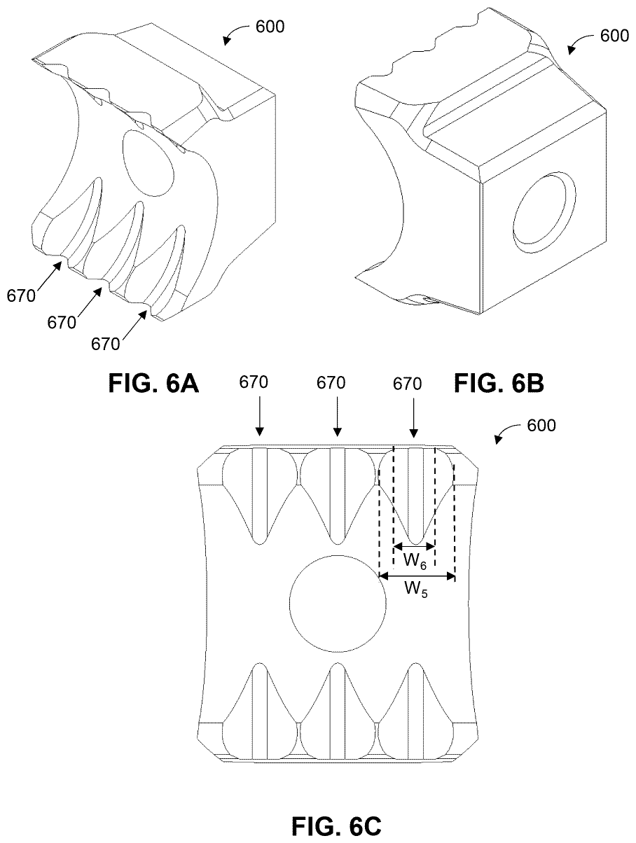

Referring now to FIGS. 6A to 6B, a cutting tool 600 having a body with substantially similar features to the body of the cutting tool 500 is shown. The cutting tool 600 differs in the shape and orientation of the grooves. As can be seen, the grooves 670 on the cutting tool 600 have a width and elongated shape that are orientated substantially perpendicular to the cutting edges 660.

As can be seen, a widest width W₅ of the grooves 670 is larger than the widest point of the grooves 570 on the cutting tool 500. In the exemplary embodiment, a width W₆ of the groove on the cutting edge 660 is less than the widest width W₅ of the groove 670.

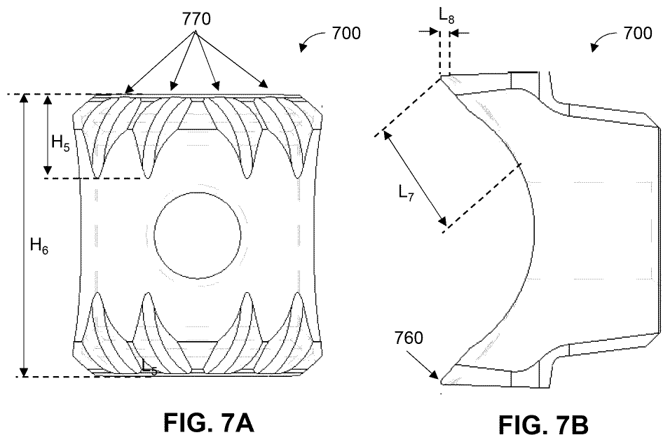

Referring now to FIGS. 7A and 7B, a cutting tool 700 having a body with substantially similar features to the body of the cutting tool 400 is shown. The cutting tool 700 differs in the shape and orientation of the grooves. As can be seen, the grooves 770 on the cutting tool 700 are curved across the cutting edges 760.

In the exemplary embodiment, a leading side height H₅ of the cutting groove edges of the grooves 770 is about 16.96 mm and a length L₇ of the cutting groove edges is about 21.48 mm. The overall height H₆ of the cutting tool 700 is 55.56 mm, meaning that the cutting groove edges on the top and bottom sides of the cutting tool 700 extend across about 61% of the overall height H₆ of the cutting tool 700. In the exemplary embodiment, a length La of the outer groove edges is about 1.88 mm, corresponding to about 9.7% of the length of the top surface of the cutting tool 700.

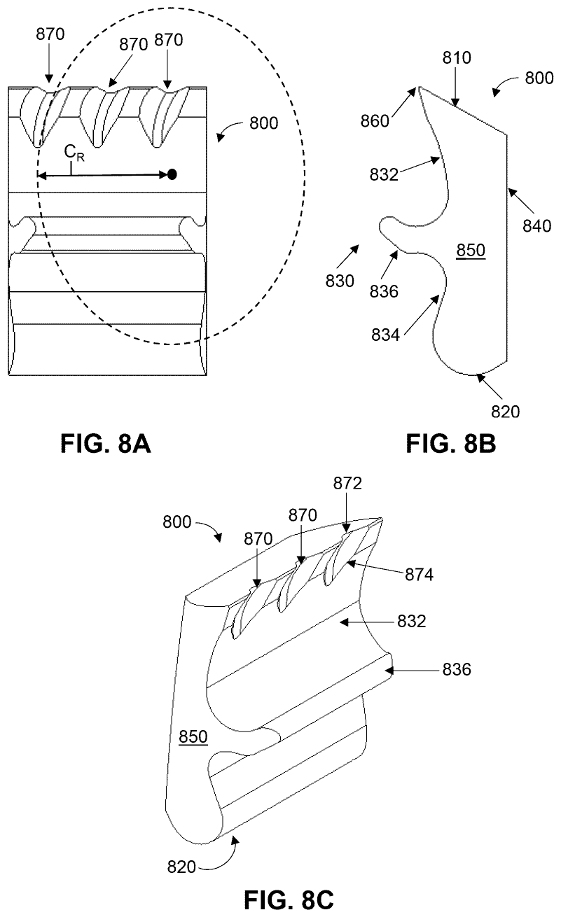

Referring now to FIGS. 8A to 8C, a cutting tool 800 according to another embodiment is shown. The cutting tool 800 comprises a body having a top surface 810, a bottom surface 820, a leading surface 830, a trialing surface 840, and side surfaces 850. In the exemplary embodiment, the leading surface 830 includes a cutting surface 832 and a coupling surface 834. The cutting surface 832 and the coupling surface 834 each comprise a concave surface that are delimited from each other by a protrusion 836. The concave surface formed by the coupling surface 834 and the protrusion 836 is configured to be retained in a tool holder or aperture within a rotary drum or disc, for example with a wedge.

In the exemplary embodiment, the cutting tool 800 includes a single cutting edge 860 formed on an apex between the top surface 810 and the cutting surface 830 (i.e., a leading side of the top surface). The cutting edge 860 can include at least one groove 870 extending through the cutting edge 860. In the exemplary embodiment, the cutting tool 800 includes three grooves 870 extending through the cutting edge 860 to form top groove edges 872 on the top surface 810 and bottom groove edges 874 on the cutting surface 832.

As shown best in FIG. 8A, the grooves 870 are curved and provided at an angle with respect to an axis extending perpendicular to the cutting edge 860. In the exemplary embodiment, each of the grooves are provided at the same angle and orientation (i.e., angled to the same side). However, other configurations are contemplated, such as grooves 870 being angled toward each other, being angled away from each other, being substantially perpendicular to the cutting edge 860, or any combination thereof. In some embodiments, the grooves 870 can be curved with a curve radius C_{R} of between about 5 mm and about 75 mm, or between about 10 mm and about 45 mm. In the exemplary embodiment, the curve radius C_{R} of the groove 770 is about 25.4 mm (or about 1 inch). In some embodiments, the grooves 870 are formed on the cutting edge 860 with a milling tool, such as a 2-inch milling tool.

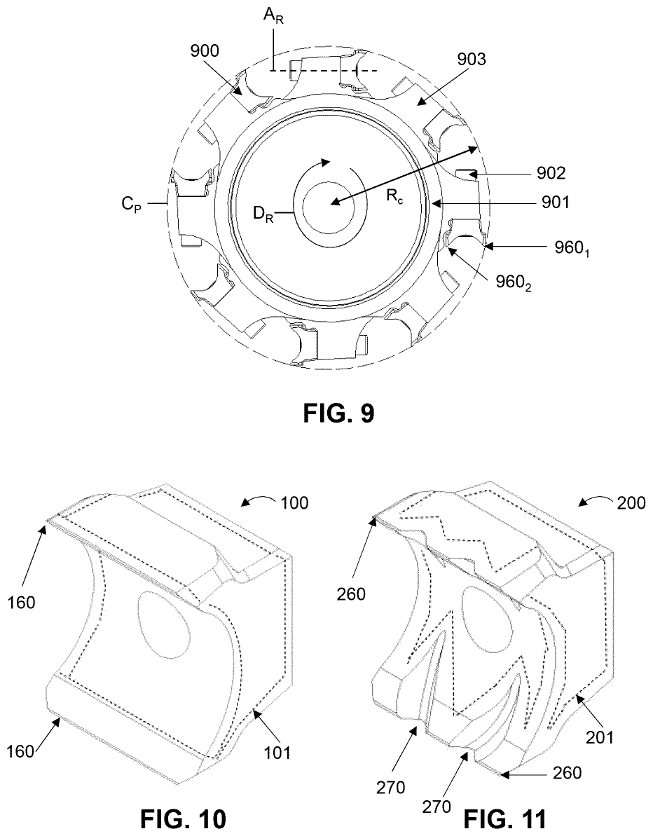

Referring now to FIG. 9, cutting tools 900 according to another embodiment are shown removably coupled to a rotary or cutting drum 901. The cutting tools 900 can have substantially the same features as cutting tools 100, 200, 300, 400, 500, 600, and/or 700. In the exemplary embodiment, the cutting tools 900 include a body with a first cutting edge 960₁ and a second cutting edge 960₂ opposite to the first cutting edge 960₁ on a leading side of the body.

As can be seen, the first and second cutting edges 960_{1,2} both face the direction of rotation D_{R} while the cutting drum 901 is in use. In some embodiments, the cutting tool 900 includes an aperture (not shown) that is configured to receive a fastener 902 to couple a trailing side of the cutting tool 900 to a leading side of the cutting drum 901 or, as shown in the exemplary embodiment, to a leading side of a tool holder 903 on the cutting drum 901.

In the exemplary embodiment, the cutting tools 900 are in a first position such that the first cutting edge 960₁ is in the cutting path C_{P}. During use in the first position, the cutting drum 901 is rotated in the direction of rotation D_{R}, such that the first cutting edge 960₁ comes into contact with the material to be shredded, mulched, or otherwise size reduced. As the first cutting edge 960₁ becomes dull or blunt from use, a cutting radius R_{C} of the rotary (i.e., a distance from a rotational axis of the cutting drum 901 to the cutting path C_{P}) is decreased. In conventional systems, when the first cutting edge 860₁ becomes dull, the fastener 902 is removed and the entire cutting tool would be removed. In the exemplary embodiment, the fastener 902 can be loosened or removed such that the cutting tool 900 can be rotated 180° along an axis of rotation A_{R} of the fastener 902. Once rotated 180° along the axis of rotation A_{R} to place the cutting tool 900 in the second position, the second cutting edge 960₂ forms the cutting path C_{P}. Once rotated, the fastener 902 can be tightened or the cutting tool 900 can be re-removably coupled to the cutting drum 901 or tool holder 903 with the fastener 902.

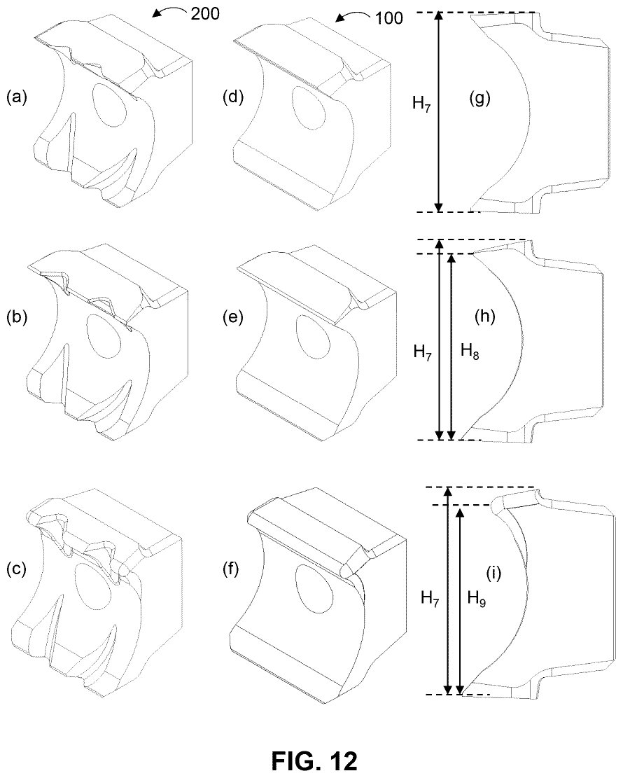

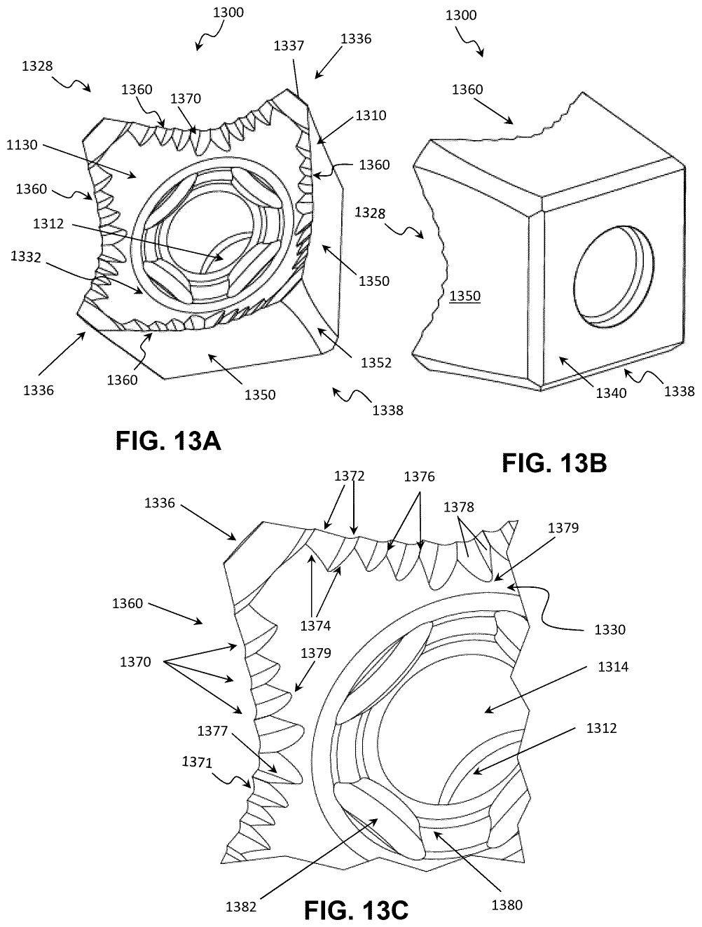

Referring now to FIGS. 10 and 11, the cutting tool 100 having two opposing straight cutting edges 160 and the cutting tool 200 having two opposing cutting edges 260 with grooves 270 extending therethrough is shown. In some embodiments, an outer surface of the cutting tool or a portion thereof (for example, the cutting edges, the groove edges, the cutting surface, the side surfaces, the top and bottom surfaces, and/or the coupling surface) can be reinforced. For example, the cutting tool can undergo case hardening to increase the hardness on the outer surface of the metal. In the exemplary embodiments, an entirety of the outer surface of the cutting tools 100, 200 includes a portion 101, 201, respectively, that has undergone case hardening or is covered in a reinforcing material. The outer surface area of the cutting tool 200 with grooves 270 has an increased outer surface area. By providing an increased outer surface area, the area hardened by the case hardening or reinforcement is increased due to the larger number of cutting surfaces that are hardened, which can increase the overall life of the cutting tool 200.

### Experimentation

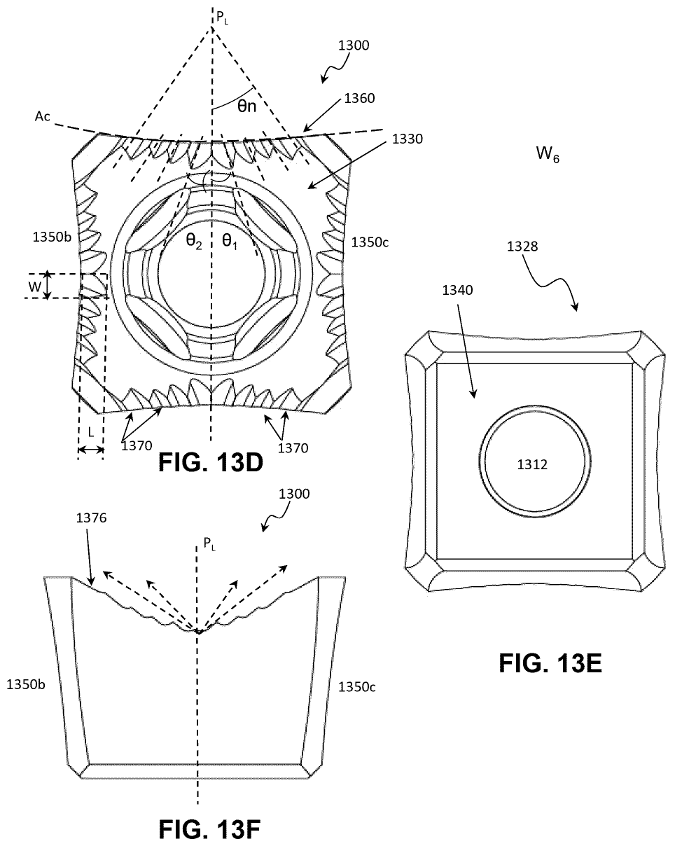

Referring now to FIG. 12, a comparison of the wear patterns of the cutting tool 100 having two opposing straight cutting edges 160 and the cutting tool 200 having two opposing cutting edges 260 with grooves 270 extending therethrough is shown. The cutting tool 200 with grooves 270 is shown with (a) no wear, (b) moderate wear, and (c) extensive wear and the cutting tool 100 with a single cutting edge 160 is shown with (d) no wear, (e) moderate wear, and (f) extensive wear. FIG. 12 also shows the matching side profile of a cutting tool, which could be cutting tool 100 or cutting tool 200, with (g) no wear, (h) moderate wear, and (i) extensive wear. In some embodiments, the side profile of the cutting tool 100 and the cutting tool 200 after having experienced the same level of wear are substantially similar; however, the cutting tool 200 with grooves 270 retains more edge surfaces (the cutting edge and the groove edges) for a longer wear period.

As can be seen, due to the larger number of cutting edges (i.e., the cutting edge 260 and the multiple groove edges), the cutting tooth 200 that includes grooves 270 maintains, or in some cases, even increases, the cutting efficiency of the cutting tool 800 due to the wear or erosion being spread across the additional cutting edges. In other words, as shown in images (b) and (c) the multiple edges created by the grooves 270 provides additional cutting surfaces in which the cutting tool 200 can engage with the material being shredded.

It is also contemplated that, when in use, the cutting tools on the cutting drum are prone to striking non-organic matter, such as rocks or small pieces of metal. During such an impact, the cutting tool with grooves (such as cutting tools 200, 300, 400, 500, 600, 700, 800) have additional edges that increase the resistance to dents caused by an impact with non-organic material because the grooved profile of the leading side of the cutting tool either are round or become round during use, thus spreading the impact of the non-organic material more evenly on the leading side without substantially reducing the productivity. For example, as shown in images (b) and (c) of FIG. 12, the groove edges of the grooves 270 are rounded, which can increase the resistance to impacts by non-organic material.

With reference to FIG. 9 and images (g) to (i) of FIG. 12, a height of the cutting tool, which is reduced with wear and erosion, has an impact on the cutting radius R_{C} because the height H₇ of the cutting tool in image (g) (i.e., no wear), which is defined by the distance between the cutting edges, is a portion of the cutting radius R_{C} of the cutting drum. However, during use, when the cutting tools 100, 200, experience moderate wear, such as shown in image (h) of FIG. 12, the height H₈ of the cutting tool is decreased, thus resulting in a cutting radius that is less than the cutting radius R_{C} of a cutting drum with cutting tools 100, 200 that do not have any wear (i.e., the height H₇ of the cutting tool prior to use is larger than the height H₈ of a cutting tool exhibiting moderate wear). Similarly, when the cutting tools 100, 200, experience extensive wear, such as shown in image (i) of FIG. 12, the height H₉ of the cutting tool is decreased further, thus resulting in a cutting radius that is less than the cutting radius of the cutting tools 100, 200 having moderate wear and the cutting radius R_{C} of a cutting drum with cutting tools 100, 200 that do not have any wear.

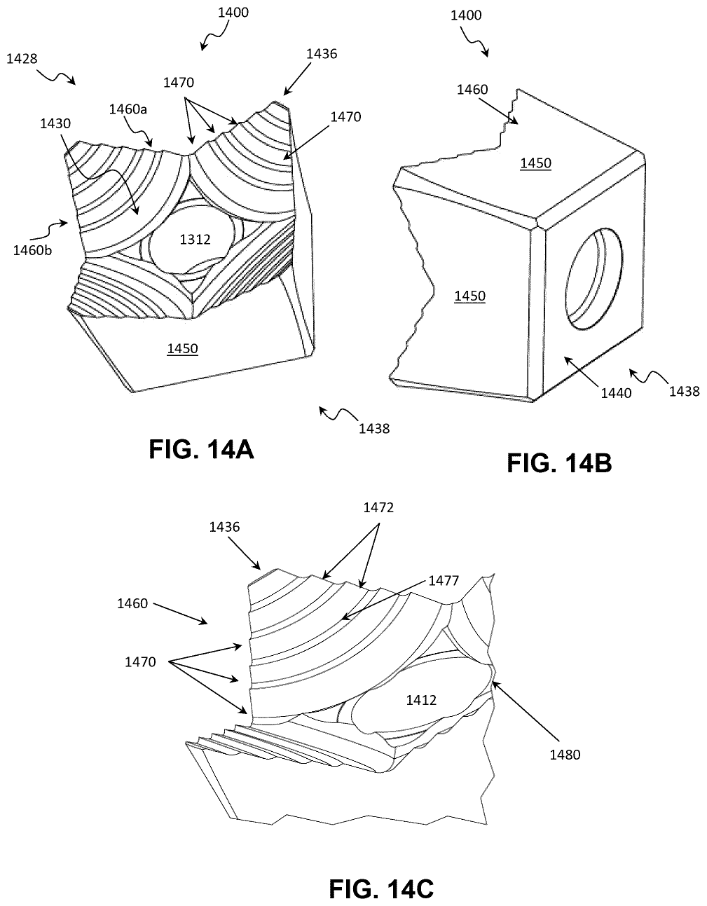

FIGS. 13 to 17 show other embodiments of cutting tools, which are particularly suitable for felling and bunching forestry equipment, but which may also be used with other types of equipment, such as mulchers. The cutting tools illustrated in FIGS. 13 to 17 are more or less cubic in shape, but with a base (which couples to a holder) smaller than the top of the tooth (cutting face), so that the body of these teeth flares from the base toward the cutting face. The cutting tools 1300, 1400 and 1500 are rotatable and comprise four tips and four cutting edges, each cutting edge being provided with grooves.

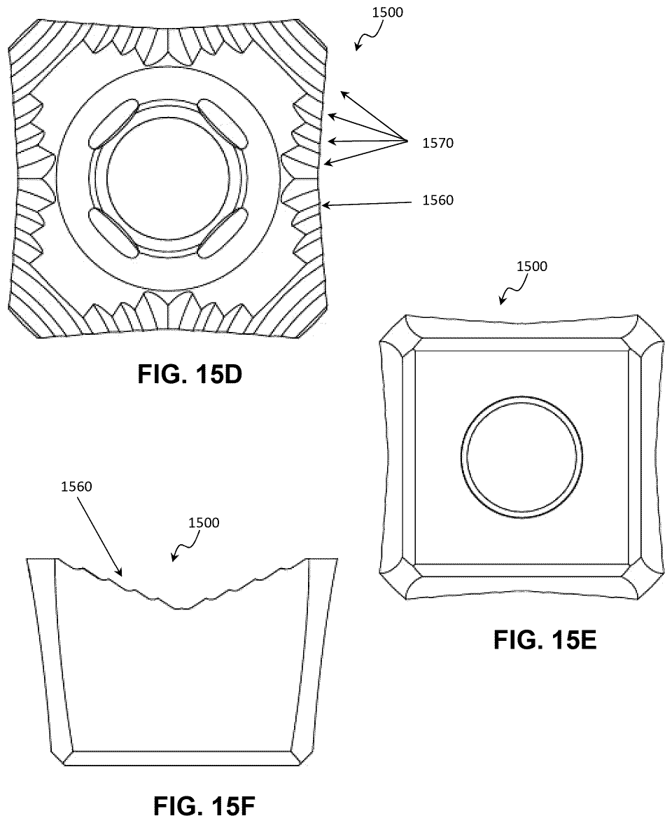

Referring to FIGS. 13A to 13F, a cutting tool 1300 for mounting onto a rotary drum or disc of a forestry equipment is shown. The forestry equipment can be equipment for cutting ligneous material, such as trees, branches, and/or brush. The cutting tool has a body 1310, typically made as a single component, preferably from high-grade alloy steel, which may be hardened and/or heat-treated. The cutting tool 1300 has a coupling side 1338 for mounting onto the rotary drum or circular saw/disc and a cutting side 1328, opposite the coupling side. The cutting tool 1300 can be mounted directly on a holder that is part of a saw disc or mounted via a holder attached to the rim of the disc, as shown in FIGS. 16, 17 and 18. The coupling side 1338 has a coupling surface 1340 which seats of a seating surface of the holder. In this configuration of the cutting tool, the coupling side 1338 of tooth 1300 can also be referred to as the coupling face, the base, the bottom side, the mounting side or the trailing end, since when the disc or drum rotates, the cutting side 1328 of the tool is exposed and attacks the wood, and the coupling face sits on the holder and trails, relative to the direction of rotation of the saw or drum. The cutting side 1328 can be referred to as the top side, the leading end or the leading face of the cutting tool.

As best shown in FIG. 13A, the cutting side 1328 has a concave cutting surface 1330 forming a pocket or recess 1332 on the upper part of the tooth/cutting tool. This pocket or recess 1332 can collect debris and may limit or reduce jamming of the cutting tool as it bites in the material, as the pocket creates a space to receive the debris prior to being discharged through the clearance formed by the recessed (center) portion of the cutting edges 1360. The cutting edges 1360 of the cutting tool attack and cut through the ligneous material. In this embodiment, the cutting tool 1330 comprises four cutting edges 1360, one on each side of the tool. The cutting tool 1300 also has four cutting tips 1336 and lateral sides or walls 1350, which are slightly curved and flared, diverging outwardly from the coupling side 1338 to the cutting side 1328. The corners of the cutting tool 1300 are chamfered (1352), creating a sharp edge 1337 at each tip 1336. The tip edges 1337 also bite in the wood. A bolt hole 1312 traverses the body of the tool, for attaching the cutting tool 1330 to the holder or other equivalent affixing component. In this embodiment, the bolt hole is a through-hole, but in other embodiments, the bolt hole may extend only partially within the body. Also, at least part of the sidewall 1314 of the hole is threaded, to mate with the bolt threads.

Similar to the embodiments presented in the previous figures, the cutting edges 1360 delimiting the cutting surface 1330 comprises a plurality of serrations or grooves 1370 defining valleys or depressions in the concave surface 1330 of the cutting side. As best show on FIG. 13C, the valleys 1371 extend at different angles relative to the cutting edge 1360 from which they originate. In possible embodiments, as the one illustrated, each groove 1370 can extend at a different angle from its neighbouring grooves, relative to the cutting edge. In other words, the general orientation of a groove differs from one groove to another. The formation of these valleys or grooves in the concave face 1330 of the tooth increases the cutting area of the cutting face, and allows the wood to be cut into smaller pieces and thus making the bite more effective and less prone to jamming. The formation of grooves on the cutting edges also increases the overall periphery (or length) of the cutting edges, creating a plurality of shorter blades that are more effective because they generate smaller fragments that are less likely to get stuck in the tooth/cutting tool pocket and can be more easily evacuated to the sides of the tooth. Thus, each cutting edge 1360, instead of being continuous, comprises a plurality of serration edges 1372, increasing the cutting-edge perimeter and thus the contact surface and periphery with the material to be cut.

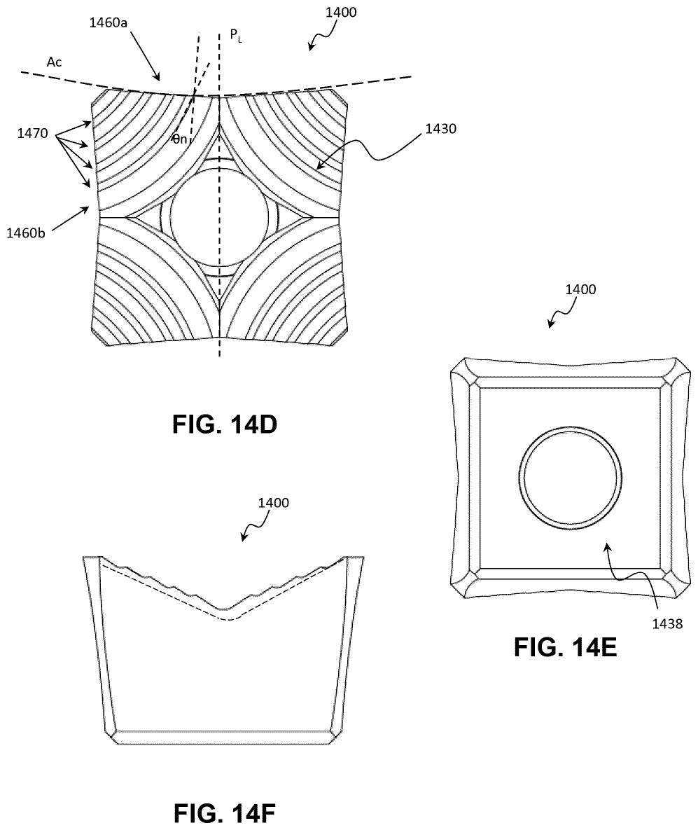

Best shown on FIG. 13C, the serration edges may comprise edges 1372 that extend along the junction of the cutting side and lateral sides of the cutting tool, and edges 1374 that extend along the cutting surface 1330. The grooves also include ridges or crests 1376 and a bottom, which may take the form of a bottom ridge 1377. The valleys or depressions may thus be delimited by ridges 1376, and two adjacent valleys may share the same ridge 1376. In some embodiments, as the one shown in FIG. 13C, each groove 1370 includes two side surfaces or sidewalls 1378, inclined toward each other and meeting at the bottom of the groove. In other words, each of the valleys comprises a bottom or base, a first side surface extending from the base and, and a second side surface opposite the first side surface. The base or bottom of each groove 1370 may be substantially planar, curved, slanted, or angled. The first side surface 1378 and/or the second side surface 1378 may also be substantially planar, curved, slanted, or angled. The serrations may form arc-shaped grooves extending between two adjacent cutting edges, as is the case in the embodiment of FIGS. 14A-14F. Each groove 1370 may also include a groove tip 1379 located on the concave cutting surface, away from the cutting edge 1360. The groove tips may end at different distances from their corresponding cutting edge, on the cutting surface 1330. The cutting tips, serration edges and ridges provide grooves with varying geometries for attacking the wood to be cut, making the cut more efficient relative to traditional cutting tools. Visible in FIGS. 13A and 13C, the cutting tool 1300 may include a slight annular mound or elevation 1380 at its center, surrounding the bolt hole 1312. This annular mound may include depressions 1382, shaped and curved to follow some of the grooves formed on the cutting edges. These elevations or mounds can be used to block debris and direct them toward the outside of the tooth, and the depressions 1382 also guide fragments and wood chips toward the sides of the cutting tool.

With reference to FIGS. 13D to 13F, other aspects of the cutting tool 1300 with grooves are visible. The view from above the cutting tool in FIG. 13D, where the cutting surface 1330 is visible, shows that each cutting edge 1360 forms an arc. The arc formed by the top cutting edge 1360 is identified as Ac. In FIG. 13D, the arc Ac formed by the cutting edge 1360 has a flared U-shape, but the cutting edge could be formed with a V-shape as well. The four cutting edges 1360 are thus V- or U-shaped, each leg or side of a given cutting edge 1360 comprising a plurality of serrations 1370. On each side of the cutting edge 1360 (half cutting edge), delimited relative to the plane P_{L} cutting the cutting tool in two along the bolt hole axis, at least two, and preferably between 2 and 5 grooves 1370 are formed. Also preferably, the grooves 1370 are oriented, or extend, in opposite orientations on each side of the cutting edges, and toward the exterior of the cutting tool. The serrations or grooves 1370 on one half of the cutting edge are preferably oriented toward one side of the cutting tool, while the grooves on the other half of the cutting edge are oriented toward the opposite side of the cutting tool, thereby directing the fragments and wood chips to either side of the cutting tool, but not to its center. More specifically, a groove may form an angle θ₁, θ₂, θₙ with respect to the cutting edge on which it is formed, and each angle may be different from one groove to another. In other words, the bottom of each valley or groove extends at an angle θₙ relative to a tangent of the cutting edge (or a groove is provided on the cutting surface at an angle θₙ with an axis perpendicular to the cutting edge.) This angle may be between 1 and 50 degrees, and preferably between 15 and 45 degrees. The grooves formed on a given edge are oriented on each side of the edge so that debris cut by the tool are directed toward the sides of the teeth (here, sides 1350b and 1350c) so as not to clog the center of the cutting tool and to facilitate the expulsion of debris. The serrations may be arranged symmetrically on each side of a plane passing through the cutting tool axially, as is the case in the cutting tool of FIGS. 13A to 13F. Also, as shown in FIG. 13F, the ridges 1376 between the grooves 1370 may be oriented toward the outside of the cutting tool 1300, relative to the plane P_{L}. FIG. 13D also shows that the grooves 1370 can not only have opposite orientations for each half-side of a cutting edge 1360, but that their width W and length L can also differ from one groove to another. Figure D shows that the ridges 1376 of the grooves also have different heights, from the center to the sides of the cutting tool. Here again, the objective is to create sharp edges and contact surfaces with different geometries and orientations to maximize contact points with the ligneous material (wood or brush), thereby enhancing the efficiency of cutting trees and shrubs while reducing the likelihood of saw or drum blockages.

FIGS. 14A to 14F show another embodiment of a cutting tool 1400 with a cutting side 1428 and a coupling side 1438, a through hole 1412, and which includes a cutting surface 1430 with four cutting edges 1460, each comprising a plurality of serrations or grooves 1470 extending from corresponding cutting edges. The cutting surface 1430 is concave and has formed thereon the grooves or serrations 1470. In this embodiment, however, the serrations or grooves 1470 are shaped as quarter circles, and extend from one cutting side of the tooth to an adjacent cutting side (such as from cutting side 1460a to 1460b). The centre of the quarter circle grooves 1370 correspond more or less to a tis of the cutting tool. Each tool tip 1436 therefore comprises curved grooves in the shape of a quarter circle. As with the first embodiment, the curvature of the grooves is such that debris are guided along the grooves toward the outer sides of the cutting tool 1400, to prevent debris from accumulating in the center of the cutting tool 1430. The cutting tool 1400 has an annular raised portion around the bolt hole, forming an annular mound 1480, with the curved grooves 1470 furthest from the tips 1436 notching part of this mound 480. As with the embodiment of FIGS. 13A-13F, the grooves 1470 extending from the cutting edges 1460 increase the overall length of the cutting edges 1360, as they if formed by the summation of all serration edges 1472, which maximizes the surface area or line of attack between the cutting tool 1400 and the ligneous material to be processed.

FIG. 14D provides a clearer view of the cutting surface 1430 of the cutting tool 1400 and the shape of the quarter-circle grooves 1470. The grooves 1470 also extend on either side of the cutting tool from the cutting edges 1460, in opposite direction on each half cutting edge, outward the cutting tool, at angles θn relative to a tangent Ac of the cutting edge 1460. FIG. 14E shows the underside of the cutting tool (corresponding to the coupling side 1438), and FIG. 14F shows a side of the cutting tool, where one can see that the cutting periphery or length is greater than if the cutting edge were continuous, without any grooves or serrations. The cutting edge that a cutting tool would have without grooves or serrations is shown as dotted lines in FIG. 14F.

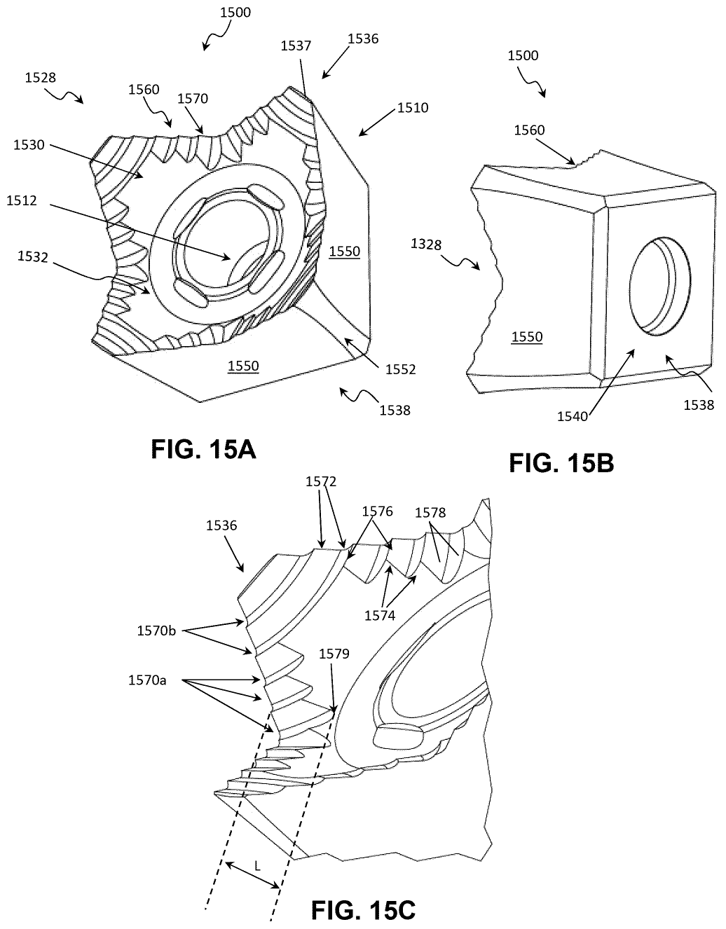

FIGS. 15A to 15F show a cutting tool 1500 according to another embodiment, which includes some of the features of the cutting tools shown in FIGS. 13A to 13F and in FIGS. 14A to 14F. Referring to FIG. 15C, the grooves/serrations 1570a closer to the center of the cutting edges extend over the concave cutting surface 1530 for a certain length L (the length L of these serrations may vary from one to another), up to a groove tip 1579, while the grooves/serrations 1570b located closer to the cutting tips 1536 extend from one cutting edge to the other, forming quarter circles. Other aspects of the cutting tool 1500 are similar to those presented above, with a coupling side 1538, a cutting side 1528, a coupling surface 1540, a concave cutting surface 1530, a threaded hole 1512 to affix the tool to a holder with a bolt, a pocket or recess 1532 formed by the concave cutting surface 1530, four lateral sides 1550, and four chamfers 1552. In FIG. 15C, the grooves 1570 include ridges 1572 and 1574, and crests 1576, all of which contribute to extending the length of the edges that can attack the ligneous material to be cut. Each groove 1570 includes inclined walls 1578, and bottom ridge. The grooves 1570 are oriented to guide the cut material away from the center of the tool, toward its side edges.

As can be appreciated, the serrations on the concave/cutting side of the cutting tool serve to increase the contact surface and the overall length of the edges in contact with the wood or ligneous material, with each edge being smaller and oriented differently from its neighbours, allowing for more efficient cutting and less jamming than when continuous cutting edges are used. In addition, the serrations can serve as wear indicators for forestry equipment operators, indicating them when it is time to rotate a cutting tool 90 or 180 degrees to expose a different cutting edge. As the cutting tool wears, the serrations will become increasingly worn and shorter, and may eventually disappear (depending on their configuration), indicating that it is time to rotate or replace the cutting tool. The curvature of the grooves or serrations toward the sides of the cutting tool directs the fragments and wood chips toward the base of the U or V of the cutting edges, facilitating their evacuation.

FIG. 16 shows an exemplary holder 1600 for receiving a cutting tool according to one of the embodiments presented above. In the figure, a cutting tool 1300 is illustrated, but another embodiment of a cutting tool may be used. To maintain the cutting tool on the holder 1600, a bolt 1604 is inserted through the through hole in the holder and through the threaded hole 1312 in the tooth 1300. A washer 1602 and/or a sleeve (not shown) may be used to better secure the tooth and/or to allow the use of bolts of a smaller diameter.

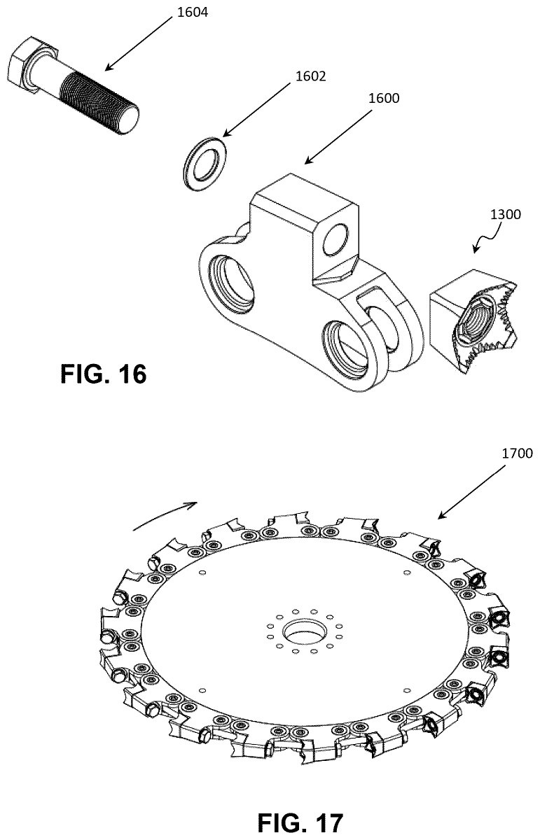

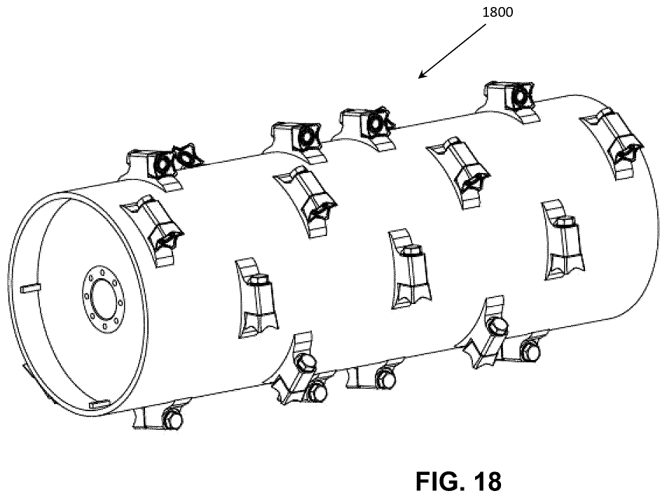

FIG. 17 shows a circular saw 1700, which can be part of feller/buncher heads or of harvesting/processing heads, with the cutting tools mounted on holders arranged around the periphery of the rotary disc 1700. FIG. 18 shows an exemplary mulcher drum 1800, the cutting tools being mounted to the drum via respective holders, arranged around the drum. This type of drum 1800 can be used in a mulching attachment heads.

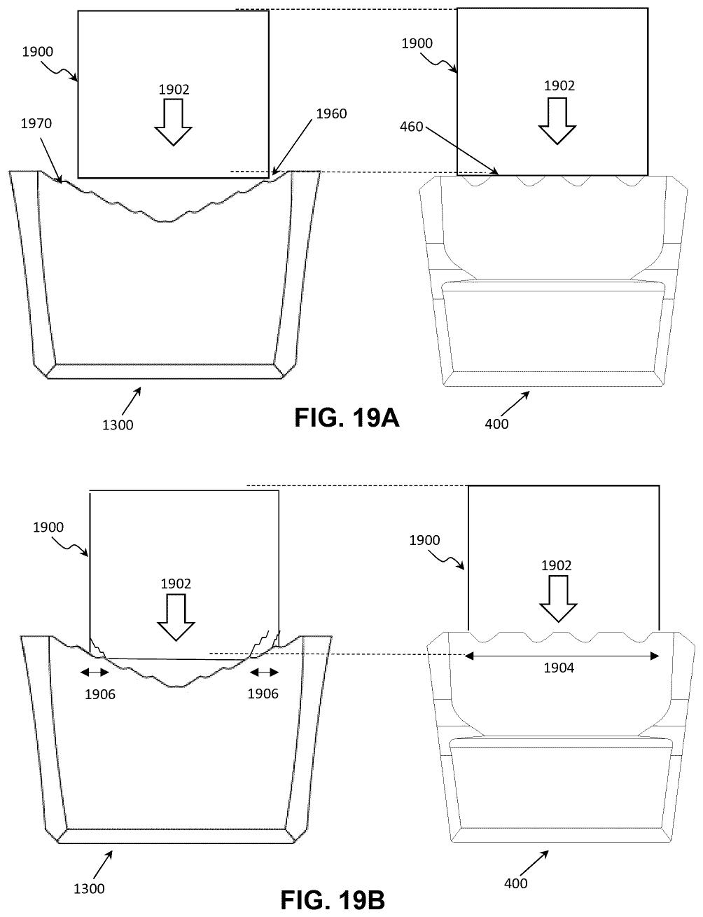

FIGS. 19A and 19B show the benefit of using a four-sided cutting tool 1900 with a concave cutting side and with curved, slightly V-shaped cutting edges 1960 provided with serrations 1970, compared to a cutting tool 400 where the serrations are provided on a straight cutting edge 460. The material 1900 (typically wood) is shown at two different instant (FIG. 19A vs 19B), and arrow 1902 indicates the material feeding direction. The dimensions of the material to be cut can of course vary, and the example shown is only illustrative, as the material to be cut (typically a tree trunk) is generally much larger than the dimensions of the tooth (from one end of the cutting edge to the other). FIG. 19B, on the left side, clearly shows how, when the cutting tool 1300 bites into the material to be cut, it gradually comes into contact with the cutting edges, compared to a tooth with a straight edge (right side of FIG. 19B). The gradual attack of the cutting edge 1960 on the material, given the curved shape of the cutting edge, combined with the serrations 1970, allows the material to be cut very finely, thus reducing the effort required for the cut and generating very small chips, almost dust, which greatly reduces the chances of jamming the saw equipped with this type of cutting tool 1300. We note that FIGS. 19A and 19B show a cutting tool 1300 according to one embodiment previously described, but other similar embodiments, such as cutting tools 1400 and 1500, would have the same effect and offer the same advantages. Arrows 1906 represent the contact width of the material to be cut, which increases gradually as the cutting tool bites into the material, while arrow 1904 shows the contact width for a straight, non-curved tooth, which remains the same throughout the cut. As can be appreciated, curved and inclined cutting edges, provided with a plurality of serrations, and recesses or depressions extending at different angles on the cutting side and relative to one of the corresponding cutting edges, allows shredding the material in small pieces, which in turn minimizes energy consumption. Thus, unlike cutting tools where the serrations are machined from a straight blade and face the material at a 90° angle when viewed from above, a cutting tool similar to embodiments presented in FIGS. 13A to 15F, with serrations machined on surfaces that are already at an angle (beaver type) to the material to be cut, results in compounded angles (a plurality of cutting edge sections extending at different angles, along all three dimensions) which allows a finer shredding. Each serration therefore takes a small bite at a time and pre-weakens the material to be shredded for the next serration. This is a significant advantage.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A cutting tool for mounting onto a rotary drum or disc of a forestry equipment for cutting ligneous material, the cutting tool comprising:
a coupling side for mounting onto the rotary drum or disc;
a cutting side opposite the coupling side, the cutting side comprising a concave surface forming a pocket, the cutting side having at least two cutting edges; and
at least two lateral sides extending from the coupling side to the cutting side;
wherein each of the cutting edges comprises a plurality of serrations defining valleys or depressions in the concave surface of the cutting side, the valleys extending at different angles relative to a corresponding one of the cutting edges.

2. The cutting tool of claim 1, comprising four cutting tips, the at least two cutting edges comprising four cutting edges, each extending between two of the four cutting tips, and wherein the at least two lateral sides comprise four lateral sides flaring from the coupling side to the cutting side.

3. The cutting tool of claim 2, wherein the cutting edges are V-shaped or U-shaped, each leg or half cutting edge of the V-shaped or U-shaped cutting edges comprising two or more serrations.

4. The cutting tool of claim 3, wherein the serrations on each side of the V-shaped or U-shaped cutting edge extend in opposite orientations.

5. The cutting tool of claim 1, wherein each of the cutting edges is formed by a plurality of serration edges.

6. The cutting tool of claim 5, wherein the serrations are arranged symmetrically on each side of a plane passing through the cutting tool axially.

7. The cutting tool of claim 1, wherein each of the valleys comprises a bottom or base, a first side surface extending from the base and, and a second side surface opposite the first side surface.

8. The cutting tool of claim 7, wherein the bottom of each valley extends at an angle relative to a tangent of the cutting edge, the angle being between 15 and 45 degrees.

9. The cutting tool of claim 8, wherein the base is substantially planar, curved, slanted, or angled.

10. The cutting tool of claim 7, wherein the first side surface and/or the second side surface is substantially planar, curved, slanted, or angled.

11. The cutting tool of claim 2, wherein at least some of the valleys or depressions are delimited by ridges, at least two adjacent valleys sharing a same ridge.

12. The cutting tool of claim 2, wherein at least some of the serrations form arc-shaped grooves extending between two adjacent cutting edges.

13. The cutting tool of claim 12, wherein the arc-shaped groove is provided on the cutting surface at an angle with an axis perpendicular to a corresponding one of the cutting edges.

14. The cutting tool of claim 2, wherein for each of the cutting edges, the serrations on one half of the cutting edge are curved and oriented toward an adjacent lateral side of the tooth, and the serrations on the other half of the cutting edge are curved and oriented toward an opposite lateral side, also adjacent to the cutting edge, so as to direct wood fragments or chips toward both lateral sides of the tooth.

15. The cutting tool of claim 1, wherein the at least two cutting edges comprise a top cutting edge on the top surface and a bottom cutting edge on the bottom surface that is opposing the top cutting edge and the serrations comprise top serrations on the top cutting edge and bottom serrations on the bottom cutting edge.

16. The cutting tool of claim 15, wherein the cutting tool is configured to be rotatable, such that the cutting tool is configured to be mounted to the rotary drum or disc in a first position with a first one of the at least two cutting edges being in a cutting path of the rotary drum or disc and in a second position with a second one of the at least two cutting edges being in the cutting path.

17. The cutting tool of claim 2, wherein the cutting tool is configured to be rotatable in four different positions, by rotating the tooth 90 degrees, each position exposing a different set of serrations along the cutting path.

18. The cutting tool of claim 2, comprising an annular elevation or mound surrounding the bolt hole, and mound depressions formed therein, the annular elevation or mound blocking wood fragments or chips from the cutting tool center, the mound depressions cooperating with the serrations provided on the cutting edges to guide the wood fragments or chips toward the opposite lateral sides of the cutting tool.

19. The cutting tool of claim 1, wherein the serrations are wear indicators, the disappearance of the serrations on one of the cutting edges indicating that the cutting tool is to be replaced or rotated to another position to expose another one of the cutting edges.

20. The cutting tool of claim 1, for use in a mulching attachment or in a felling head.
